(19) United States
(12) Patent Application Publication
(10) Pub. No.: US 2020/0226869 A1
(43) Pub. Date: Jul. 16, 2020

(54) MEDICINE DISPENSER

(71) Applicant: ZION COHEN-DANIEL, Beer Yaakov (IL)

(72) Inventor: ZION COHEN-DANIEL, Beer Yaakov (IL)

(21) Appl. No.: 16/655,279

(22) Filed: Oct. 17, 2019

Related U.S. Application Data
(60) Provisional application No. 62/790,480, filed on Jan. 10, 2019.

(51) Int. Cl. G07F 17/00; A61J 7/00; A61J 7/04

(52) U.S. Cl. CPC G07F 17/0092; A61J 7/0069; A61J 7/04; A61J 7/0084

(57) ABSTRACT

A medicine dispenser, including a medicine prescription reader, for reading a medicine prescription including two due times, trays, each for containing medicine doses of one type only, and a robot, for dispensing medicine doses from at the trays to two cells of box according to the reading of the medicine prescription reader, thereby dedicating each of the cells to one of the due times.

### CROSS-REFERENCE TO RELATED APPLICATIONS

This application claims the benefit of priority from U.S. Provisional Application No. 62/790,480, filed Jan. 10, 2019, the disclosure of which is incorporated herein by reference.

### TECHNICAL FIELD

The invention relates to the field of medical prescriptions and medicine provision.

### BACKGROUND

Issue of medicines, storage and sale of drugs constitute an expensive logistical process and is not always available according to the needs of the patient. The drug identification process is done in a way that is not sufficiently safe.

There is a long felt need to provide a solution to the above-mentioned and other problems of the prior art.

### SUMMARY

A medicine dispenser, including:
a medicine prescription reader;
trays, each for containing medicine doses of one type; and
a robot, for dispensing medicine doses to the cells.

### BRIEF DESCRIPTION OF THE DRAWINGS

Embodiments, features, and aspects of the invention are described herein in conjunction with the following drawings:

FIG. 1 is a medicine dispenser according to one embodiment, from the client's side.

FIG. 2 is the medicine dispenser of FIG. 1 from the pharmacist side.

FIG. 3 describes the input and output of the medicine dispenser of FIG. 1 at a first step.

FIG. 4 describes the input and output of the medicine dispenser of FIG. 1 at a second step.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

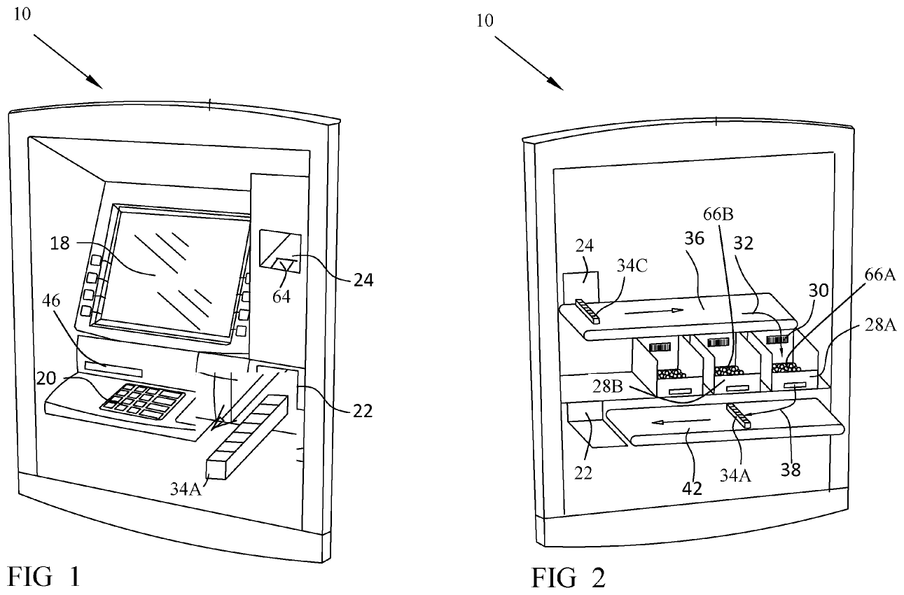

FIG. 1 is a medicine dispenser according to one embodiment, from the client's side.

FIG. 2 is the medicine dispenser of FIG. 1 from the pharmacist side.

A client may provide a medicine prescription, and receive a medicine box 34A from outlet 22 of a medicine dispenser 10 according to one embodiment.

According to one embodiment, the client may further provide a medicine box 34C, for receiving medicine box 34A, considering medicine box 34C.

The term “medicine dose” refers herein to any medicine for being completely consumed at a certain time, such as a pill, tablet, liquid dose, etc.

Medicine dispenser 10 transfers medicine doses of medicine box 34C into medicine trays 28A, 28B, etc., as shown by arrow 32; and transfers from medicine doses from medicine trays 28A, 28B, etc. into medicine box 34A, as shown by arrow 38.

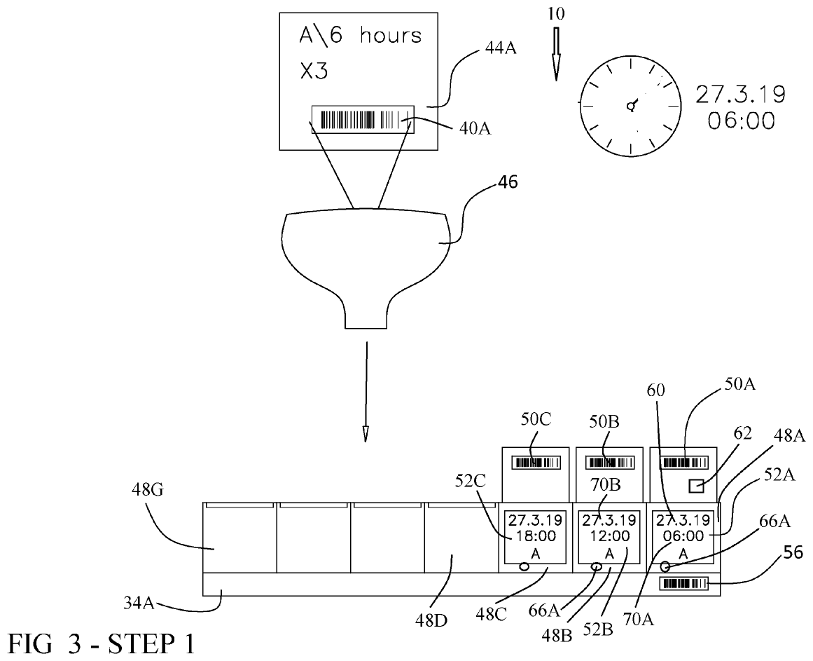

FIG. 3 describes the input and output of the medicine dispenser of FIG. 1 at a first step.

FIG. 3 depicts an example of a barcode reader 46 of medicine dispenser 10 reading at the first step, being at 6:00 o'clock of date 27 Mar. 2019, a barcode 40A of medicine prescription 44A, instructing to dispense 3 medicine doses of type A one per 6 hours.

Accordingly, medicine dispenser 10 dispenses medicine box 34A, including a plurality of cells, of which cells 48A, 48B and 48C contain medicine of type A, and cells 48D to 48G are empty.

For example, tray 28A may include 10 liters of liquid medicine, and cell 48A containing medicine of type A may include 5 milliliters from tray 28A being sterilely packaged.

Medicine dispenser 10 further stamps user readable instructions 60 explaining barcode 40A of medicine prescription 44A to each of cells 48A, 48B and 48C, such as by sticking stickers 52A, 52B and 52C.

According to the due times example of 3 medicine doses of type A one per 6 hours, sticker 52A of cell 48A may indicate medicine A at due time 70A of 6 o'clock; sticker 52B of cell 48A may indicate medicine A at a due time 70B of 12 o'clock; and sticker 52C of cell 48C may indicate medicine A at 18 o'clock.

Sticker 52A may further include a barcode 50A including the information of cell 48A, such as user readable instructions 60 of cell 48A; sticker 52A may include a barcode 50B for cell 48B; and sticker 52C may include a barcode 50C for cell 48C.

Barcodes 50A, 50B and 50C may include visual and/or vocal gadgets 62, for alerting the information thereof. For example, a bulb 62 of barcode 50A may blink at 6 o'clock.

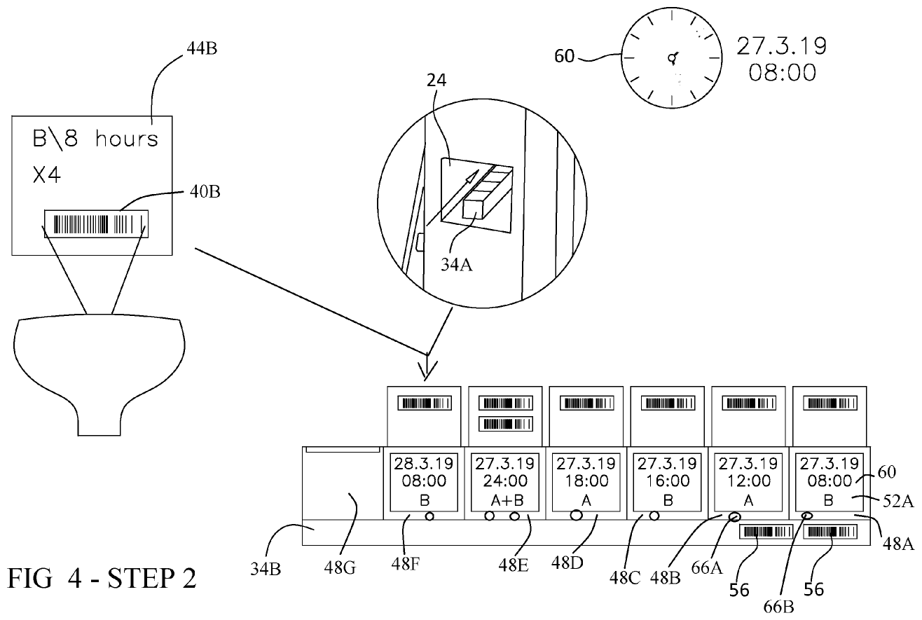

FIG. 4 describes the input and output of the medicine dispenser of FIG. 1 at a second step.

At the second step, being after consuming the first medicine dose of type A of medicine box 34A, FIG. 4 depicts an example of barcode reader 46 reading at 8:00 o'clock of date 27 Mar. 2019, a new medicine prescription 44B including a new barcode 40B, instructing to dispense 4 medicine doses of type B one per 8 hours.

FIG. 4 further depicts that the user decides to return medicine box 34A.

Referring again to FIG. 1, inlet 24 of medicine dispenser 10 includes a barcode reader 64, thereby reading barcodes 50A, 50B and 50C, thus knowing the physical contents of medicine box 34A.

Referring again to FIG. 4, accordingly, medicine dispenser 10 dispenses a new medicine box 34B considering barcodes 40A and 40B.

Thus, and considering the first medicine dose of type A of medicine box 34A has been consumed, cell 48A contains a medicine dose of type B; cell 48B contains a medicine dose of type A; cell 48C contains a medicine dose of type B; cell 48D contains a medicine dose of type A; cell 48E contains one medicine dose of type A and another medicine dose of type B; cell 48F contains one medicine dose of type B; and cell 48G is empty.

Medicine dispenser 10 further stamps user readable instructions 60 explaining the combination of barcodes 40A and 40B of medicine prescriptions 44A and 44B to each of the cells.

Thus, in this case, the sticker 52A of cell 48A indicates medicine B at 8 o'clock of date 27 Mar. 2019; cell 48B indicates medicine A at 12 o'clock; cell 48C indicates medicine B at 16 o'clock; cell 48D indicates medicine A at 18 o'clock; cell 48E indicates medicines A and B at 24 o'clock, yet of date 27 Mar. 2019; and cell 48F indicates medicine B at 8 o'clock of date 28 Mar. 2019, thus providing artificial intelligence.

Trays 28A, 28B, etc., cells 48A, 48B, etc. and robot 36 may be sterilized, for providing sterilized dispensing from mass packaging to personal packaging.

Thus, in one aspect, the invention is directed to a medicine dispenser (10), including:
a medicine prescription reader (46), for reading a medicine prescription (44A) including due times (70A,70B);
trays (28A,28B), each for containing medicine doses of one type only;
a robot (36), for dispensing medicine doses (66A) from at the trays (28A) to cells (48A,48B) of box (34A), according to the reading of the medicine prescription reader (46),
thereby dedicating each (48A) of the cells to one (70A) of the due times.

The trays (28A,28B), the cells (48A,48B) of the box (34A), and the robot (36) may be sterilized,
thereby providing sterilized dispensing from mass packaging of the trays (28A,28B) to personal packaging of the box (34A).

The dedicating of each (48A) of the cells to one (70A) of the due times, may include presentations (60) disposed on the first box (34A) of at least the due times (70A).

The presentations (60) disposed on the first box (34A) of at least the due times (70A) may constitute alerts (62).

The medicine dispenser (10) may further include a barcode reader (64), wherein the presentations (60) disposed on the box (34A) of at least the due times (70A) may include a barcode (50A), for being readable by the barcode reader (64).

The first medicine prescription (44A) may include the first medicine prescription (44A) and a second medicine prescription (44B),
thereby the dispensing is according to a combination of the first (44A) and second (44B) medicine prescriptions.

The medicine dispenser (10) may further include:
an inlet (24), for receiving a second box (34B) including the medicine doses (66A) dispensed according to the second medicine prescription (44B),
   thereby dispensing according to the second medicine prescription (44B) more than one time.

In the figures and/or description herein, the following reference numerals (Reference Signs List) have been mentioned:
numeral 10 denotes the medicine dispenser according to one embodiment of the invention;
18: display;
20: keyboard;
22: outlet;
24: inlet;
28A,28B: medicine trays;
30: barcode indicating type of medicines in tray 28A;
32: arrow;
34A,34B,34C: boxes dispensed by medicine dispenser 10, each including a plurality of cells;
36: robot including a conveyor;
38: arrow;
40A,40B: barcodes including information of prescriptions;
42: arrow;
44A,44B: medicine prescriptions;
46: medicine prescription reader, which may read a printed or an electronic sheet;
48A,48B,48C,48D,48E,48G: cells of dispensed box 34A;
50A,50B,50C: barcodes describing the information of dispensed box 34A; each may describe the information of one cell;
52A,52B,52C: stickers;
56: a single barcode describing the entire contents of box 34A;
60: instructions/presentations attached to dispensed box 34A, such as stickers 52A readable to the user and/or being alerts to the user and/or being barcodes 50A readable to medicine dispenser 10, for re-dispensing its contents as a combination with another box;
62: bulb or loudspeaker for alerting; each bulb may alert a certain cell to consume from;
64: barcode reader;
66A,66B: medicine doses, each of another type;
70A,70B: due time for consuming a dose;

The foregoing description and illustrations of the embodiments of the invention have been presented for the purpose of illustration, and are not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A medicine dispenser, comprising:
a medicine prescription reader, for reading at least a first medicine prescription comprising at least two due times;
a plurality of trays, each for containing medicine doses of one type only;
a robot, for dispensing medicine doses from at least one of said trays to at least two cells of a first box, according to said reading of said medicine prescription reader,
thereby dedicating each of said at least two cells to one of said at least two due times.

2. The medicine dispenser according to claim 1, wherein said plurality of trays, said at least two cells of said first box, and said robot are sterilized,
thereby providing sterilized dispensing from mass packaging of said trays to personal packaging of said first box.

3. The medicine dispenser according to claim 1, wherein said dedicating of each of said at least two cells to one of said at least two due times, comprises presentations disposed on said first box of at least said due times.

4. The medicine dispenser according to claim 3, wherein said presentations disposed on said first box of at least said due times comprise alerts.

5. The medicine dispenser according to claim 3, further comprising a barcode reader, wherein said presentations disposed on said first box of at least said due times comprise at least one barcode, for being readable by said barcode reader.

6. The medicine dispenser according to claim 1, wherein said at least first medicine prescription comprises said first medicine prescription and a second medicine prescription,
thereby said dispensing is according to a combination of said first and second medicine prescriptions.

7. The medicine dispenser according to claim 6, further comprising:
an inlet for receiving a second box comprising said medicine doses dispensed according to said second medicine prescription,
thereby dispensing according to said second medicine prescription more than one time.
